(19) United States
(12) Patent Application Publication
(10) Pub. No.: US 2021/0081754 A1
(43) Pub. Date: Mar. 18, 2021

(54) ERROR CORRECTION IN CONVOLUTIONAL NEURAL NETWORKS

(71) Applicant: eyeSight Mobile Technologies Ltd., Herzliya (IL)

(72) Inventors: Darya FROLOVA, Tel Aviv (IL); Ishay SIVAN, Tel Aviv (IL)

(21) Appl. No.: 16/960,879

(22) PCT Filed: Jan. 8, 2019
(86) PCT No.: PCT/US2019/012717

§ 371 Date: Jul. 8, 2020

Related U.S. Application Data
(60) Provisional application No. 62/614,602, filed on Jan. 8, 2018.

(51) Int. Cl. G06N 3/04; G06N 3/08

(52) U.S. Cl. CPC G06N 3/04; G06N 3/08

(57) ABSTRACT

Systems and methods are disclosed for error correction in convolutional neural networks. In one implementation, a first image is received. A first activation map is generated with respect to the first image within a first layer of the convolutional neural network. A correlation is computed between data reflected in the first activation map and data reflected in a second activation map associated with a second image. Based on the computed correlation, a linear combination of the first activation map and the second activation map is used to process the first image within a second layer of the convolutional neural network. An output is provided based on the processing of the first image within the second layer of the convolutional neural network.

### CROSS-REFERENCE TO RELATED APPLICATIONS

This application is related to and claims the benefit of priority to U.S. Patent Application No. 62/614,602, filed Jan. 8, 2018, which is incorporated herein by reference in its entirety.

### TECHNICAL FIELD

Aspects and implementations of the present disclosure relate to data processing and, more specifically, but without limitation, to error correction in convolutional neural networks.

### BACKGROUND

Convolutional neural networks are a form of deep neural networks. Such neural networks may be applied to analyzing visual imagery and/or other content.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system, in accordance with an example embodiment.

FIG. 2 illustrates an example scenario described herein, according to an example embodiment.

FIG. 3 illustrates an example scenario described herein, according to an example embodiment.

FIG. 4 is a flow chart illustrating a method for error correction in convolutional neural networks, in accordance with an example embodiment.

FIG. 5 is a block diagram illustrating components of a machine able to read instructions from a machine-readable medium and perform any of the methodologies discussed herein, according to an example embodiment.

### DETAILED DESCRIPTION

Aspects and implementations of the present disclosure are directed to error correction in convolutional neural networks.

Convolutional neural networks are a form of deep neural networks such as may be applied to analyzing visual imagery and/or other content. Such neural networks can include multiple connected layers that include neurons arranged in three dimensions (width, height, and depth). Such layers can be configured to analyze or process images. For example, by applying various filter(s) to an image, one or more feature maps/activation maps can be generated. Such activation maps can represent a response or result of the application of the referenced filter(s), e.g., with respect to a layer of a convolutional neural network in relation to at least a portion of the image. In another example, an input image can be processed through one or more layers of the convolutional neural network to create a set of feature/activation maps. Accordingly, respective layers of a convolutional neural networks can generate a set or vector of activation maps (reflecting the activation maps that correspond to various portions, regions, or aspects of the image). In certain implementations, such activation map(s) can include, for example, the output of one or more layer(s) within the convolutional neural network (“CNN”), a dataset generated during the processing of an image by the CNN (e.g., at any stage of the processing of the image). In certain implementations, the referenced activation maps can include a dataset that may be a combination and/or manipulation of data generated during the processing of the image in the CNN (with such data being, for example, a combination of data generated by the CNN and data from a repository).

In certain implementations, the described system can be configured to detect an event, such as when an object covers at least part of an observed object (e.g. a hand covers the face of the driver, an object held by the driver covers part of the face of the driver, etc.).

Additionally, in certain implementations the described system can be implemented with respect to driver monitoring systems (DMS), occupancy monitoring systems (OMS), etc. For example, detection of occlusions of objects that may interfere in detecting features associated with DMS (such as features related to head pose, locations of driver eyes, gaze direction, facial expressions). By way of further example, detection of occlusions that may interfere in detection or prediction of driver behavior and activity.

Various aspects of the disclosed system(s) and related technologies can include or involve machine learning. Machine learning can include one or more techniques, algorithms, and/or models (e.g., mathematical models) implemented and running on a processing device. The models that are implemented in a machine learning system can enable the system to learn and improve from data based on its statistical characteristics rather on predefined rules of human experts. Machine learning focuses on the development of computer programs that can access data and use it to learn for themselves to perform a certain task.

Machine learning models may be shaped according to the structure of the machine learning system, supervised or unsupervised, the flow of data within the system, the input data and external triggers.

Machine learning can be related as an application of artificial intelligence (AI) that provides systems the ability to automatically learn and improve from data input without being explicitly programmed.

Machine learning may apply to various tasks, such as feature learning, sparse dictionary learning, anomaly detection, association rule learning, and collaborative filtering for recommendation systems. Machine learning may be used for feature extraction, dimensionality reduction, clustering, classifications, regression, or metric learning. Machine learning systems may be supervised and semi-supervised, unsupervised, reinforced. Machine learning system may be implemented in various ways including linear and logistic regression, linear discriminant analysis, support vector machines (SVM), decision trees, random forests, ferns, Bayesian networks, boosting, genetic algorithms, simulated annealing, or convolutional neural networks (CNN).

Deep learning is a special implementation of a machine learning system. In one example, deep learning algorithms discover multiple levels of representation, or a hierarchy of features, with higher-level, more abstract features extracted using lower-level features. Deep learning may be implemented in various feedforward or recurrent architectures including multi-layered perceptrons, convolutional neural networks, deep neural networks, deep belief networks, autoencoders, long short term memory (LSTM) networks, generative adversarial networks, and deep reinforcement networks.

The architectures mentioned above are not mutually exclusive and can be combined or used as building blocks for implementing other types of deep networks. For example, deep belief networks may be implemented using autoencoders. In turn, autoencoders may be implemented using multi-layered perceptrons or convolutional neural networks.

Training of a deep neural network may be cast as an optimization problem that involves minimizing a predefined objective (loss) function, which is a function of networks parameters, its actual prediction, and desired prediction. The goal is to minimize the differences between the actual prediction and the desired prediction by adjusting the network's parameters. Many implementations of such an optimization process are based on the stochastic gradient descent method which can be implemented using the back-propagation algorithm. However, for some operating regimes, such as in online learning scenarios, stochastic gradient descent have various shortcomings and other optimization methods have been proposed.

Deep neural networks may be used for predicting various human traits, behavior and actions from input sensor data such as still images, videos, sound and speech.

In another implementation example, a deep recurrent LSTM network is used to anticipate driver's behavior or action few seconds before it happens, based on a collection of sensor data such as video, tactile sensors and GPS.

In some embodiments, the processor may be configured to implement one or more machine learning techniques and algorithms to facilitate detection/prediction of user behavior-related variables. The term “machine learning” is non-limiting, and may include techniques including, but not limited to, computer vision learning, deep machine learning, deep learning, and deep neural networks, neural networks, artificial intelligence, and online learning, i.e. learning during operation of the system. Machine learning algorithms may detect one or more patterns in collected sensor data, such as image data, proximity sensor data, and data from other types of sensors disclosed herein. A machine learning component implemented by the processor may be trained using one or more training data sets based on correlations between collected sensor data or saved data and user behavior related variables of interest. Save data may include data generated by other machine learning system, preprocessing analysis on sensors input, data associated with the object that is observed by the system. Machine learning components may be continuously or periodically updated based on new training data sets and feedback loops.

Machine learning components can be used to detect or predict gestures, motion, body posture, features associated with user alertness, driver alertness, fatigue, attentiveness to the road, distraction, features associated with expressions or emotions of a user, features associated with gaze direction of a user, driver or passenger. Machine learning components can be used to detect or predict actions including talking, shouting, singing, driving, sleeping, resting, smoking, reading, texting, holding a mobile device, holding a mobile device against the cheek, holding a device by hand for texting or speaker calling, watching content, playing a digital game, using a head mount device such as smart glasses, VR, AR, device learning, interacting with devices within a vehicle, fixing the safety belt, wearing a seat belt, wearing seatbelt incorrectly, opening a window, getting in or out of the vehicle, picking an object, looking for an object, interacting with other passengers, fixing the glasses, fixing/putting eyes contacts, fixing the hair/dress, putting lips stick, dressing or undressing, involvement in sexual activities, involvement in violent activity, looking at a mirror, communicating with another one or more persons/systems/AIs using digital device, features associated with user behavior, interaction with the environment, interaction with another person, activity, emotional state, emotional responses to: content, event, trigger another person, one or more object, learning the vehicle interior.

Machine learning components can be used to detect facial attributes including head pose, gaze, face and facial attributes 3D location, facial expression, facial landmarks including: mouth, eyes, neck, nose, eyelids, iris, pupil, accessories including: glasses/sunglasses, earrings, makeup; facial actions including: talking, yawning, blinking, pupil dilation, being surprised; occluding the face with other body parts (such as hand, fingers), with other object held by the user (a cap, food, phone), by other person (other person hand) or object (part of the vehicle), user unique expressions (such as Tourette's Syndrome related expressions).

Machine learning systems may use input from one or more systems in the vehicle, including ADAS, car speed measurement, L/R turn signals, steering wheel movements and location, wheel directions, car motion path, input indicating the surrounding around the car, SFM and 3D reconstruction.

Machine learning components can be used to detect the occupancy of a vehicle's cabin, detecting and tracking people and objects, and acts according to their presence, position, pose, identity, age, gender, physical dimensions, state, emotion, health, head pose, gaze, gestures, facial features and expressions. Machine learning components can be used to detect one or more person, person recognition/age/gender, person ethnicity, person height, person weight, pregnancy state, posture, out-of-position (e.g. legs up, lying down, etc.), seat validity (availability of seatbelt), person skeleton posture, seat belt fitting, an object, animal presence in the vehicle, one or more objects in the vehicle, learning the vehicle interior, an anomaly, child/baby seat in the vehicle, number of persons in the vehicle, too many persons in a vehicle (e.g. 4 children in rear seat, while only 3 allowed), person sitting on other person's lap.

Machine learning components can be used to detect or predict features associated with user behavior, action, interaction with the environment, interaction with another person, activity, emotional state, emotional responses to: content, event, trigger another person, one or more object, detecting child presence in the car after all adults left the car, monitoring back-seat of a vehicle, identifying aggressive behavior, vandalism, vomiting, physical or mental distress, detecting actions such as smoking, eating and drinking, understanding the intention of the user through their gaze or other body features.

When analyzing/processing images within a convolutional neural network, challenges arise in scenarios in which such images contain occlusions or other defects that obscure portions of the content within the image. For example, in scenarios in which image(s) being analyzed via a convolutional neural network correspond to human heads/faces (e.g., to identify the angle/direction the head of such a user is oriented), certain images may include occlusions that obscure portions of such a head/face. For example, a user may be wearing a hat, glasses, jewelry, or may touch his/her face. Processing image(s) captured under such circumstances (which contain occlusions that obscure portions of the face/head of the user) may result in inaccurate results from a convolutional neural network (e.g., a convolutional neural network configured or trained with respect to images that do not contain such occlusions).

Accordingly, described herein in various implementations are systems, methods, and related technologies for error correction in convolutional neural networks. As described herein, the disclosed technologies overcome the referenced shortcomings and provide numerous additional advantages and improvements. For example, the disclosed technologies can compare one or more activation maps generated with respect to a newly received image with corresponding activation maps associated with various reference images (with respect to which an output—e.g., the angle of a head of a user—is known). In doing so, at least a part of the reference set of activation maps most correlated with the newly received image can be identified. The activation maps of the received image and those of the reference image can then be compared to identify those activation maps within the received image that are not substantially correlated with corresponding activation maps in the reference image. Those activation maps that are not substantially correlated can then be substituted for the corresponding activation maps from the reference image, thereby generating a corrected set of activation maps. Such a corrected set can be provided for processing through subsequent layers of the convolutional neural network. In doing so, the described technologies can enhance the operation of such convolutional neural networks by enabling content to be identified in a more efficient and accurate manner, even in scenarios in which occlusions are present in the original input. By performing the described operation(s) (including the substitution of activation map(s) associated with reference images), the performance of various image recognition operations can be substantially improved.

It can therefore be appreciated that the described technologies are directed to and address specific technical challenges and longstanding deficiencies in multiple technical areas, including but not limited to image processing, convolutional neural networks, and machine vision. As described in detail herein, the disclosed technologies provide specific, technical solutions to the referenced technical challenges and unmet needs in the referenced technical fields and provide numerous advantages and improvements upon conventional approaches. Additionally, in various implementations one or more of the hardware elements, components, etc., referenced herein operate to enable, improve, and/or enhance the described technologies, such as in a manner described herein.

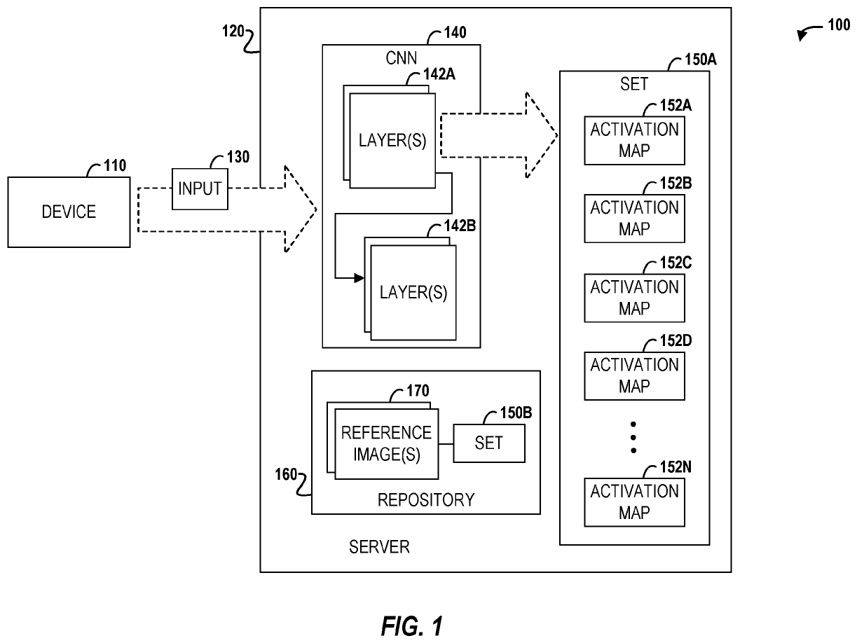

FIG. 1 illustrates an example system 100, in accordance with some implementations. As shown, the system 100 includes device 110 which can be a computing device, mobile device, sensor, etc., that generates and/or provides input 130. For example, device 110 can be an image acquisition device (e.g., a camera), image sensor, IR sensor, etc. In certain implementations, deice 110 can include or otherwise integrate one or more processor(s), such as those that process image(s) and/or other such content captured by the sensor. In other implementations, the sensor can be configured to connect and/or otherwise communicate with other device(s) (as described herein), and such devices can receive and process the referenced image(s).

In certain implementations, the referenced sensor(s) can be an image acquisition device (e.g., a camera), image sensor, IR sensor, or any other such sensor described herein. Such a sensor can be positioned or oriented within a vehicle (e.g., a car, bus, or any other such vehicle used for transportation). In certain implementations, the sensor can include or otherwise integrate one or more processor(s) that process image(s) and/or other such content captured by the sensor. In other implementations, the sensor can be configured to connect and/or otherwise communicate with other device(s) (as described herein), and such devices can receive and process the referenced image(s).

The sensor (e.g., a camera) may include, for example, a CCD image sensor, a CMOS image sensor, a light sensor, an IR sensor, an ultrasonic sensor, a proximity sensor, a shortwave infrared (SWIR) image sensor, a reflectivity sensor, an RGB camera, a black and white camera, or any other device that is capable of sensing visual characteristics of an environment. Moreover, the sensor may include, for example, a single photosensor or 1-D line sensor capable of scanning an area, a 2-D sensor, or a stereoscopic sensor that includes, for example, a plurality of 2-D image sensors. In certain implementations, a camera, for example, may be associated with a lens for focusing a particular area of light onto an image sensor. The lens can be narrow or wide. A wide lens may be used to get a wide field-of-view, but this may require a high-resolution sensor to get a good recognition distance. Alternatively, two sensors may be used with narrower lenses that have an overlapping field of view; together, they provide a wide field of view, but the cost of two such sensors may be lower than a high-resolution sensor and a wide lens.

The sensor may view or perceive, for example, a conical or pyramidal volume of space. The sensor may have a fixed position (e.g., within a vehicle). Images captured by sensor 130 may be digitized and input to the at least one processor, or may be input to the at least one processor in analog form and digitized by the at least one processor.

It should be noted that the sensor, as well as the various other sensors depicted and/or described and/or referenced herein may include, for example, an image sensor configured to obtain images of a three-dimensional (3-D) viewing space. The image sensor may include any image acquisition device including, for example, one or more of a camera, a light sensor, an infrared (IR) sensor, an ultrasonic sensor, a proximity sensor, a CMOS image sensor, a shortwave infrared (SWIR) image sensor, or a reflectivity sensor, a single photosensor or 1-D line sensor capable of scanning an area, a CCD image sensor, a reflectivity sensor, a depth video system comprising a 3-D image sensor or two or more two-dimensional (2-D) stereoscopic image sensors, and any other device that is capable of sensing visual characteristics of an environment. A user or other element situated in the viewing space of the sensor(s) may appear in images obtained by the sensor(s). The sensor(s) may output 2-D or 3-D monochrome, color, or IR video to a processing unit, which may be integrated with the sensor(s) or connected to the sensor(s) by a wired or wireless communication channel

Input 130 can be one or more image(s), such as those captured by a sensor and/or digitized by a processor. Examples of such images include but are not limited to sensor data of a user's head, eyes, face, etc. Such image(s) can be captured in different frame rates (FPS)).

The referenced processor(s) may include, for example, an electric circuit that performs a logic operation on an input or inputs. For example, such a processor may include one or more integrated circuits, microchips, microcontrollers, microprocessors, all or part of a central processing unit (CPU), graphics processing unit (GPU), digital signal processors (DSP), field-programmable gate array (FPGA), an application-specific integrated circuit (ASIC), or any other circuit suitable for executing instructions or performing logic operations. The at least one processor may be coincident with or may constitute any part of a processing unit such as a processing unit which may include, among other things, a processor and memory that may be used for storing images obtained by the image sensor. The processing unit may include, among other things, a processor and memory that may be used for storing images obtained by the sensor(s). The processing unit and/or the processor may be configured to execute one or more instructions that reside in the processor and/or the memory. Such a memory may include, for example, persistent memory, ROM, EEPROM, EAROM, SRAM, DRAM, DDR SDRAM, flash memory devices, magnetic disks, magneto optical disks, CD-ROM, DVD-ROM, Blu-ray, and the like, and may contain instructions (i.e., software or firmware) or other data. Generally, the at least one processor may receive instructions and data stored by memory. Thus, in some embodiments, the at least one processor executes the software or firmware to perform functions by operating on input data and generating output. However, the at least one processor may also be, for example, dedicated hardware or an application-specific integrated circuit (ASIC) that performs processes by operating on input data and generating output. The at least one processor may be any combination of dedicated hardware, one or more ASICs, one or more general purpose processors, one or more DSPs, one or more GPUs, or one or more other processors capable of processing digital information.

Images captured by a sensor may be digitized by the sensor and input to the processor, or may be input to the processor in analog form and digitized by the processor. Example proximity sensors may include, among other things, one or more of a capacitive sensor, a capacitive displacement sensor, a laser rangefinder, a sensor that uses time-of-flight (TOF) technology, an IR sensor, a sensor that detects magnetic distortion, or any other sensor that is capable of generating information indicative of the presence of an object in proximity to the proximity sensor. In some embodiments, the information generated by a proximity sensor may include a distance of the object to the proximity sensor. A proximity sensor may be a single sensor or may be a set of sensors. System 100 may also include multiple types of sensors and/or multiple sensors of the same type. For example, multiple sensors may be disposed within a single device such as a data input device housing some or all components of system 100, in a single device external to other components of system 100, or in various other configurations having at least one external sensor and at least one sensor built into another component of system 100.

The processor may be connected to or integrated within the sensor via one or more wired or wireless communication links, and may receive data from the sensor such as images, or any data capable of being collected by the sensor, such as is described herein. Such sensor data can include, for example, sensor data of a user's head, eyes, face, etc. Images may include one or more of an analog image captured by the sensor, a digital image captured or determined by the sensor, a subset of the digital or analog image captured by the sensor, digital information further processed by the processor, a mathematical representation or transformation of information associated with data sensed by the sensor, information presented as visual information such as frequency data representing the image, conceptual information such as presence of objects in the field of view of the sensor, etc. Images may also include information indicative the state of the sensor and or its parameters during capturing images e.g. exposure, frame rate, resolution of the image, color bit resolution, depth resolution, field of view of sensor 130, including information from other sensor(s) during the capturing of an image, e.g. proximity sensor information, acceleration sensor (e.g., accelerometer) information, information describing further processing that took place further to capture the image, illumination condition during capturing images, features extracted from a digital image by the sensor, or any other information associated with sensor data sensed by the sensor. Moreover, the referenced images may include information associated with static images, motion images (i.e., video), or any other visual-based data. In certain implementations, sensor data received from one or more sensor(s) may include motion data, GP S location coordinates and/or direction vectors, eye gaze information, sound data, and any data types measurable by various sensor types. Additionally, in certain implementations, sensor data may include metrics obtained by analyzing combinations of data from two or more sensors.

In certain implementations, the processor may receive data from a plurality of sensors via one or more wired or wireless communication links. In certain implementations, processor 132 may also be connected to a display, and may send instructions to the display for displaying one or more images, such as those described and/or referenced herein. It should be understood that in various implementations the described, sensor(s), processor(s), and display(s) may be incorporated within a single device or distributed across multiple devices having various combinations of the sensor(s), processor(s), and display(s).

As noted above, in certain implementations, in order to reduce data transfer from the sensor to an embedded device motherboard, processor, application processor, GPU, a processor controlled by the application processor, or any other processor, the system may be partially or completely integrated into the sensor. In the case where only partial integration to the sensor, ISP or sensor module takes place, image preprocessing, which extracts an object's features (e.g., related to a predefined object), may be integrated as part of the sensor, ISP or sensor module. A mathematical representation of the video/image and/or the object's features may be transferred for further processing on an external CPU via dedicated wire connection or bus. In the case that the whole system is integrated into the sensor, ISP or sensor module, a message or command (including, for example, the messages and commands referenced herein) may be sent to an external CPU. Moreover, in some embodiments, if the system incorporates a stereoscopic image sensor, a depth map of the environment may be created by image preprocessing of the video/image in the 2D image sensors or image sensor ISPs and the mathematical representation of the video/image, object's features, and/or other reduced information may be further processed in an external CPU.

In certain implementations, the sensor can be positioned to capture or otherwise receive image(s) or other such inputs of a user (e.g., a human user who may be the driver or operator of a vehicle). Such image(s) can be captured in different frame rates (FPS)). As described herein, such image(s) can reflect, for example, various aspects of the face of a user, including but not limited to the gaze or direction of eye(s) of the user, the position (location in space) and orientation of the face of the user, etc.

It should be understood that the scenarios depicted and described herein are provided by way of example. Accordingly, the described technologies can also be configured or implemented in various other arrangements, configurations, etc. For example, a sensor can be positioned or located in any number of other locations (e. g., within a vehicle). For example, in certain implementations the sensor can be located above a user, in front of the user (e. g., positioned on or integrated within the dashboard of a vehicle), to the side to of the user, and in any number of other positions/locations. Additionally, in certain implementations the described technologies can be implemented using multiple sensors (which may be arranged in different locations).

In certain implementations, input 130 can be provided by device 110 to server 120, e.g., via various communication protocols, network connections. Server 120 can be a machine or device configured to process various inputs, e.g., as described herein.

It should be understood that the scenario depicted in FIG. 1 is provided by way of example. Accordingly, the described technologies can also be configured or implemented in other arrangements, configurations, etc. For example, the components of device 110 and server 120 can be combined into a single machine or service (e.g., that both captures images and processes them in the manner described herein). By way of further example, components of server 120 can be distributed across multiple machines (e.g., repository 160 can be an independent device connected to server 120).

Server 120 can include elements such as convolutional neural network (‘CNN’) 140. CNN 140 can be a deep neural network such as may be applied to analyzing visual imagery and/or other content. In certain implementations, CNN 140 can include multiple connected layers, such as sets of layers 142A and 142B (collectively, layers 142) as shown in FIG. 1. Examples of such layers include but are not limited to convolutional layers, rectified linear unit (‘RELU’) layers, pooling layers, fully connected layers, and normalization layers. In certain implementations, such layers can include neurons arranged in three dimensions (width, height, and depth), with neurons in one layer being connected to a small region of the layer before it (e.g., instead of all of the neurons in a fully-connected manner)

Each of the described layers can be configured to process input 130 (e.g., an image) and/or aspects or representations thereof. For example, an image can be processed through one or more convolutional and/or other layers to generate one or more feature maps/activation maps. In certain implementations, each activation map can represent an output of the referenced layer in relation to a portion of an input (e.g. an image). Accordingly, respective layers of a CNN can generate and/or provide a set or vector of activation maps (reflecting the activation maps that correspond to various portions, regions, or aspects of the image) of different dimensions.

By way of illustration, FIG. 1 depicts input 130 (e.g., an image originating from device 110) that can be received by server 120 and processed by CNN 140. In such a scenario, the referenced input can be processed in relation to one or more layers 142A of the CNN. In doing so, set 150A can be generated and/or output by such layers 142A. As shown in FIG. 1, set 150A can be a set of activation maps (here, activation map 152A, activation map 152B, etc.) generated and/or output layers 142A of CNN 140.

Server 120 can also include repository 160. Repository 160 can include one or more reference image(s) 170. Such reference images can be images with respect to which various determinations or identifications have been previously computed or otherwise defined. Each of the reference images can include or be associated with a set, such as set 150B as shown in FIG. 1. Such a set can be a set of activation maps generated and/or output by various layers of CNN 140.

Upon computing a set of activation maps with respect to a particular layer of CNN 140 (e.g., set 150A as shown in FIG. 1, which is computed with respect to input 130), such a set can be compared with one or more sets associated with reference images 170. By comparing the respective sets (e.g., set 150A, corresponding to activation maps computed with respect to input 130, and set 150B corresponding to a reference image or images) the set associated with such reference images that is closest or most closely matches or correlates with set 150A can be identified. Various techniques can be used to identify such a correlation, including but not limited to Pearson correlation, sum of absolute or square differences, Goodman-Kruskel gamma coefficient, etc. To identify such a correlation, the referenced correlation techniques can be applied to one or more activation maps of the referenced set, as described herein. A correlation measure between two sets of activation maps can be, for example, a sum or average of correlations of some or all of the corresponding activation maps pairs, or a maximal value of the correlation between corresponding activation maps, or another suitable function. Based on the value of such a correlation measure (e.g., a final correlation measure), a reference set of activation maps is identified as being most correlated to the vector set generated with respect to the received input.

Having identified a set within repository 160 as being most correlated to the set generated with respect to the received input, a degree or measure of similarity between respective activation maps from such sets can be computed. For example, having identified set 150B as being most closely correlated to set 150A, a Pearson correlation coefficient (PCC) (or any other such similarity metric) can be computed with respect to the respective activation maps from such sets. In certain implementations, such a metric can reflect a value between −1 and 1 (with zero reflecting no correlation, 1 reflecting a perfect correlation, and −1 reflecting negative correlation).

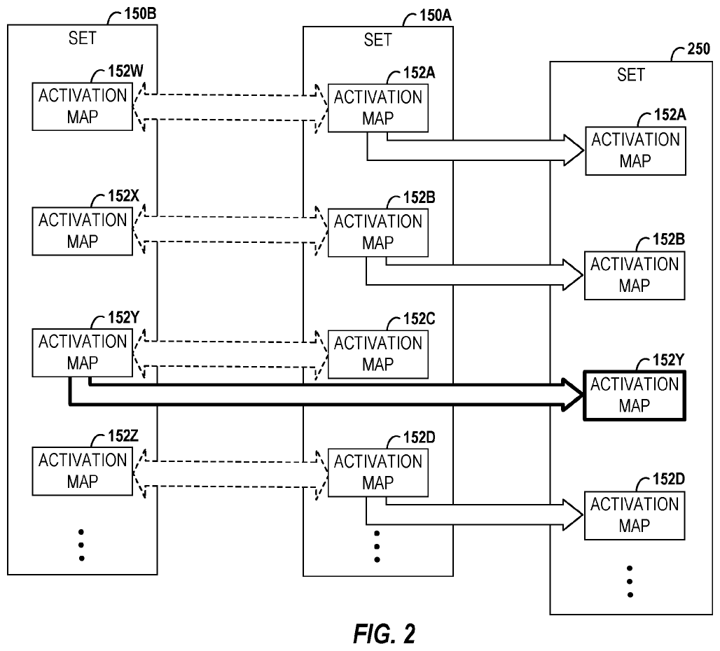

By way of illustration, FIG. 2 depicts an example scenario in which the referenced similarities are computed with respect to the respective activation maps of set 150A (corresponding to input 130) and set 150B (corresponding to one or more referenced image(s) 170). One or more criteria (e.g., a threshold) can be defined to reflect whether a computed similarity reflects a result that is satisfactory (e.g., within an image recognition process). For example, a Pearson correlation coefficient (PCC) value of 0.6 can be defined as a threshold that reflects a satisfactory result (e.g., with respect to identifying content within input 130). In scenarios in which the comparison between corresponding activation maps results in a PCC value below the defined threshold, such an activation map can be identified as a candidate for modification in the CNN. Such a candidate for modification can reflect, for example, an occlusion that may affect various aspects of the processing/identification of input 130.

Accordingly, in the scenario depicted in FIG. 2, the respective activation maps of set 150A (corresponding to input 130) and set 150B (corresponding to reference image(s) 170) can be compared and a similarity value can be computed for each respective comparison. As shown in FIG. 2, the similarity value for activation maps 152A, 152B and 152D (as compared with activation maps 152W, 152X, and 152Z, respectively, of set 150B) meets or exceeds certain defined criteria (e.g., a PCC value threshold of 0.6). Accordingly, such activation maps can be identified as being sufficiently close to the referenced reference image(s) (e.g., in order to enable the identification of content within input 130).

In contrast, activation map 152C—as compared with activation map 152Y of set 150B—can be determined not to meet the referenced criteria (e.g., with a PCC value below 0.6). Accordingly, activation map 152C can be identified as a candidate for modification within the CNN, reflecting, for example, an occlusion that may affect various aspects of the processing/identification of input 130.

Having identified activation map 152C as a candidate for modification within the CNN, the corresponding activation map from the reference image (here, activation map 152Y) can be substituted. In doing so, a new or updated set 250 can be generated. As shown in FIG. 2, such a set 250 can include activation maps determined to substantially correlate with those in the reference image (here, activation maps 152A, 152B, and 152D), together with activation map(s) associated with reference image(s) that correspond to activation map(s) from the input that did not substantially correlate with the reference image (here, activation map 152Y).

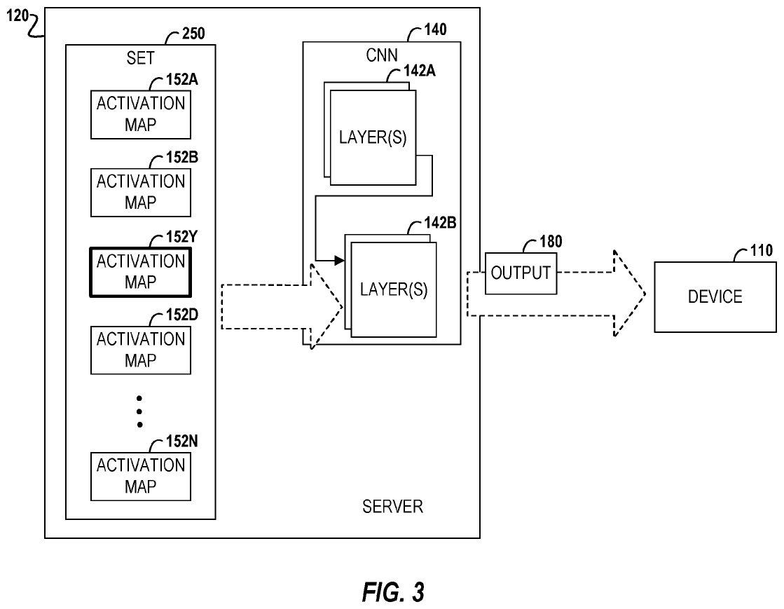

Having generated a new/updated set 250, such a set can be further utilized as input with respect to one or more subsequent layer(s) 142B of CNN 140. By way of illustration, FIG. 3 depicts set 250 (which includes activation map 152Y substituted for original activation map 152C) being input into CNN 140, for further processing (e.g., with respect to layers 142B). CNN can then continue its processing based on the referenced set, and then can provide one or more output(s) 180. In certain implementations, such outputs can include various identifications or determinations, e.g., with respect to content present within the received input 130. In doing so, the described technologies can identify such content in a more efficient and accurate manner, even in scenarios in which occlusions are present in the original input. By performing the described operation(s) (including the substitution of activation map(s) associated with reference images), the performance of various image recognition operations can be substantially improved.

In some implementations, the described technologies can be configured to initiate various action(s), such as those associated with aspects, characteristics, phenomena, etc. identified within captured or received images. The action performed (e.g., by a processor) may be, for example, generation of a message or execution of a command (which may be associated with detected aspect, characteristic, phenomenon, etc.). For example, the generated message or command may be addressed to any type of destination including, but not limited to, an operating system, one or more services, one or more applications, one or more devices, one or more remote applications, one or more remote services, or one or more remote devices.

It should be noted that, as used herein, a ‘command’ and/or ‘message’ can refer to instructions and/or content directed to and/or capable of being received/processed by any type of destination including, but not limited to, one or more of: operating system, one or more services, one or more applications, one or more devices, one or more remote applications, one or more remote services, or one or more remote devices.

In certain implementations, various operations described herein can result in the generation of a message or a command addressed to an operating system, one or more services, one or more applications, one or more devices, one or more remote applications, one or more remote services, or one or more remote devices.

It should be noted that as used herein a command and/or message can be addressed to any type of destination including, but not limited to, one or more of operating system, one or more services, one or more applications, one or more devices, one or more remote applications, one or more remote services, or one or more remote devices.

The presently disclosed subject matter may further include communicating with an external device or website responsive to selection of a graphical element. The communication may comprise sending a message to an application running on the external device, a service running on the external device, an operating system running on the external device, a process running on the external device, one or more applications running on a processor of the external device, a software program running in the background of the external device, or to one or more services running on the external device. The method may further comprise sending a message to an application running on the device, a service running on the device, an operating system running on the device, a process running on the device, one or more applications running on a processor of the device, a software program running in the background of the device, or to one or more services running on the device.

The presently disclosed subject matter may further include, responsive to a selection of a graphical element, sending a message requesting a data relating to a graphical element identified in an image from an application running on the external device, a service running on the external device, an operating system running on the external device, a process running on the external device, one or more applications running on a processor of the external device, a software program running in the background of the external device, or to one or more services running on the external device.

The presently disclosed subject matter may further include, responsive to a selection of a graphical element, sending a message requesting a data relating to a graphical element identified in an image from an application running on the device, a service running on the device, an operating system running on the device, a process running on the device, one or more applications running on a processor of the device, a software program running in the background of the device, or to one or more services running on the device.

The message to the external device or website may be a command. The command may be selected for example, from a command to run an application on the external device or website, a command to stop an application running on the external device or website, a command to activate a service running on the external device or website, a command to stop a service running on the external device or website, or a command to send data relating to a graphical element identified in an image.

The message to the device may be a command. The command may be selected for example, from a command to run an application on the device, a command to stop an application running on the device or website, a command to activate a service running on the device, a command to stop a service running on the device, or a command to send data relating to a graphical element identified in an image.

The presently disclosed subject matter may further include, responsive to a selection of a graphical element, receiving from the external device or website data relating to a graphical element identified in an image and presenting the received data to a user. The communication with the external device or website may be over a communication network.

Commands and/or messages executed by pointing with two hands can include for example selecting an area, zooming in or out of the selected area by moving the fingertips away from or towards each other, rotation of the selected area by a rotational movement of the fingertips. A command and/or message executed by pointing with two fingers can also include creating an interaction between two objects such as combining a music track with a video track or for a gaming interaction such as selecting an object by pointing with one finger, and setting the direction of its movement by pointing to a location on the display with another finger.

It should also be understood that the various components referenced herein can be combined together or separated into further components, according to a particular implementation. Additionally, in some implementations, various components may run or be embodied on separate machines. Moreover, some operations of certain of the components are described and illustrated in more detail herein.

The presently disclosed subject matter can also be configured to enable communication with an external device or website, such as in response to a selection of a graphical (or other) element. Such communication can include sending a message to an application running on the external device, a service running on the external device, an operating system running on the external device, a process running on the external device, one or more applications running on a processor of the external device, a software program running in the background of the external device, or to one or more services running on the external device. Additionally, in certain implementations a message can be sent to an application running on the device, a service running on the device, an operating system running on the device, a process running on the device, one or more applications running on a processor of the device, a software program running in the background of the device, or to one or more services running on the device.

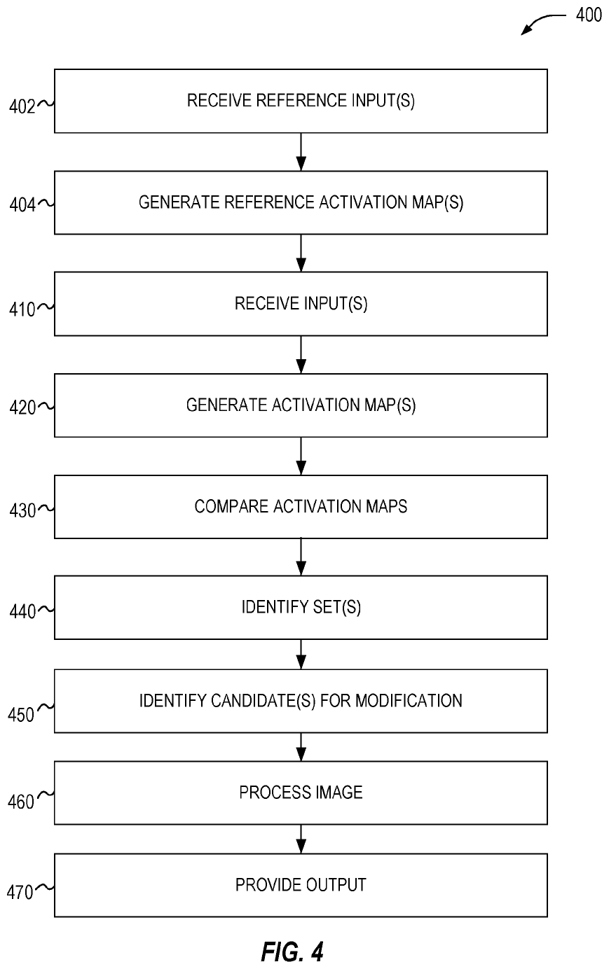

FIG. 4 is a flow chart illustrating a method 400, according to an example embodiment, for error correction in convolutional neural networks. The method is performed by processing logic that can comprise hardware (circuitry, dedicated logic, etc.), software (such as is run on a computing device such as those described herein), or a combination of both. In one implementation, the method 400 (and the other methods described herein) is/are performed by one or more elements depicted and/or described in relation to FIG. 1 (including but not limited to server 120 and/or integrated/connected computing devices, as described herein). In some other implementations, the one or more blocks of FIG. 4 can be performed by another machine or machines.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At operation 402, one or more reference input(s) (e.g., reference image(s)), is/are received. Such reference image(s) 170 can be one or more images captured/processed prior to the capture of subsequent images/inputs (e.g., as received at 410, as described herein). For example, as shown in FIG. 1, device 110 can be a sensor that captures one or more reference image(s) (e.g., prior to the capture of input 130). Such reference image(s) can be provided by device 110 to server 120 and stored in repository 160. For example, such reference image(s) can be an image(s) of the same human that is the subject of input 130, captured at a previous moment of time.

At operation 404, a first reference activation map/set of activation maps is generated, e.g., with respect to the reference input/image(s) received at 402. In certain implementations, such a reference activation map/set of activation maps 150B can be generated within one or more layers of the convolutional neural network, e.g., in a manner comparable to that described herein with respect to input 130 (e.g., at 420). Such reference activation maps can be used in comparison with activation maps generated with respect to subsequently captured images, as described in detail herein.

At operation 410, a first input, such as an image, is received. For example, as shown in FIG. 1, device 110 can be a sensor that captures one or more image(s). Such image(s) can be provided by device 110 as input 130 and received by server 120.

At operation 420, a first activation map/set of activation maps is generated, e.g., with respect to the input/image(s) received at 410. In certain implementations, such an activation map/set of activation maps can be generated within one or more layers of the convolutional neural network (e.g., convolutional layers, RELU layers, pooling layers, fully connected layers, normalization layers, etc.). In certain implementations, the described operations can generate a set or vector of activation maps for an image (reflecting activation maps that correspond to various portions, regions, or aspects of the image).

For example, as shown in FIG. 1, input 130 (e.g., an image from device 110) can be processed in relation to layer(s) 142A of CNN 140. In doing so, set 150A, which includes activation map 152A, activation map 152B, etc. can be generated and/or output by such layer(s) 142A.

It should be understood that, in certain implementations, the number of activation maps in the referenced set can be defined by the structure of CNN 140 and/or layer(s) 142. For example, in a scenario in which a selected convolutional layer 142A of CNN 140 includes 64 filters, the referenced set will have 64 corresponding activation maps.

At operation 430, a set of activation maps generated with respect to the first image (e.g., at 420) is compared with one or more set(s) of activation maps generated with respect to various reference image(s) (e.g., as generated at 404). Such reference images can be images with respect to which various determinations or identifications have been previously computed or otherwise defined (e.g., a predefined ground truth value, reflecting, for example, a head pose of a user). In certain implementations, each of the reference images can include or be associated with a set of activation maps generated and/or output by various layers of CNN 140 (e.g., reference image(s) 170 associated with set 150B, as shown in FIG. 1).

In certain implementations, the referenced set of activation maps generated with respect to the first image (e.g., set 150A as shown in FIG. 1) can be compared with multiple sets, each of which may be associated with a different reference image. In doing so, the set associated with such reference images that is closest or most closely matches or correlates with set 150A can be identified. Such a correlation can be identified or determined using any number of techniques, such as those described and/or referenced herein (e.g., Pearson correlation, sum of absolute or square differences, Goodman-Kruskel gamma coefficient, etc.). In one implementation, a value is set for the correlations between input activation maps (e.g., those generated with respect to the first image/input) and reference activation maps (e.g., those generated with respect to reference image(s). In one example, such a value can be a sum or average of correlations of some or all of the corresponding activation map pairs, or a maximal value of the correlation between corresponding activation maps, or another suitable function. Based on the set value, one or more activation maps are identified with respect to the received input.

It should be noted that in certain implementations the referenced set 150A can be compared to sets associated with reference image(s) 170 based on each of the activation maps within the sets. In other implementations, such a comparison can be performed on the basis of only some of the activation maps (e. g., activation maps from filter numbers 2, 12, and 51 out of 64 total activation maps). Additionally, in certain implementations the referenced comparison can be performed in relation to the respective images (e.g., by comparing the input image and the reference image(s), in addition to or in lieu of comparing the respective activation maps, as described herein).

In certain implementations, the described reference image(s) 170 can be previously captured/processed images with respect to which various identifications, determinations, etc., have been computed or otherwise assigned (e.g., a reference database of images of human faces in various positions, angles, etc.). Additionally, in certain implementations the described reference images can be image(s) captured by device 110, e.g., prior to the capture of input 130 (e.g., at 402, 404). Having captured such prior images, the images can be compared and determined to sufficiently correlate to other referenced image(s) 170 (e.g., in a manner described herein). Having determined that such prior image(s) correlate with stored reference image(s) 170, the referenced prior image(s) can be utilized as reference images with respect to processing subsequently captured images (e.g., input 130, as described herein). Utilizing such recently captured/processed image(s) as reference images can be advantageous due to the expected high degree of correlation between content identified in such prior image(s) and content present in images currently being processed.

By way of further illustration, in certain implementations, the reference image can be a collection of one of more images (e.g., from a database). Moreover, in certain implementations the reference image can be an image of the same human (e.g., from a previous moment of time). The image selected from a previous moment of time can be selected, for example, by correlating the image to another reference image (e.g., from database/repository 160), and it is selected if the correlation output between the prior image and the image from the database does not introduce any correlation of any activation map below a predefined threshold. It should also be noted that, in certain implementations, for each activation map a different reference image can be utilized.

In certain implementations the described reference image can be identified and/or selected using any number of other techniques/approaches. Additionally, in certain implementations the described reference image can be a set of reference images. In such a scenario, the activation map used to replace the activation map of the input image can be a linear or other such combination of activation maps from the repository/set of reference images.

In certain implementations, a reference image can be identified/selected from a set of candidate reference images based on data associated with the input image. For example, feature(s) extracted from the input image (such as recognition of the user in the image, detection of the gender/age/height/ethnicity of the user in the image) can be used to identify/select reference image(s) (e.g., reference image(s) associated with the same or related feature(s)).

Additionally, in certain implementations the described reference image can be identified/selected using/based on information about the context in which the input image was captured by an image sensor. Such information (about the context in which the input image was captured by an image sensor) can include or reflect, for example, that the image was captured in the interior of a car, a probable body posture of the user (e.g., the user is sitting in driver seat), the time of the day, lighting condition, the location and position of the camera in relation to the observed object (e.g. face of the user user), features associated with the face of the user, features related to the face of the user, user gaze, facial actions (e.g., talking, yawning, blinking, pupil dilation, being surprised, etc.), and/or activities or behavior of a user.

In certain implementations, a reference image can be identified/selected using/based on data associated with a type of occlusion (e.g., a gesture of drinking a cup of coffee, a gesture of yawning, etc.). In one implementation, the reference image can be an image captured and/or saved in the memory that reflects or corresponds to one or more frames prior to the occurrence of the referenced gesture/occlusion.

Additionally, in certain implementations the described reference image can be identified/selected using/based on a defined number of future frames to be captured.

It should be understood that an image to be used from the repository of reference image may be pre-processed or transformed, e.g., before being used as described herein as a reference image. In one implementation, such a transformation may can be a geometrical transformation (e.g., scaling the image up or down, rotating it, or performing photometrical transformation(s) such as brightness or contrast correction). In another implementation, the referenced transformation can include changing an RGB image to an image that would have being captured by IR sensor. In another implementation, the referenced preprocessing can include removing or adding an object to the image (e.g., glasses, etc.).

It should be understood that a ‘clean’ image can be an image that contains an object of interest, and the object of interest is not affected by occlusions, visible artifacts or other defects. For example, in the case of a system configured to detect various poses of the head of a user, such ‘clean’ images can contain a single face which is not occluded by extraneous objects like sunglasses, hand, cup etc., and are not affected by hard shadows or a strong light. For such a ‘clean’ image, the CNN should return an output that is close to its ground truth value. In the case of a head pose detection system, a CNN takes as input an image of a human face and outputs the head pose parameters, e.g., yaw, pitch and/or roll angles.

In certain implementations, the reference image repository/database 160 can be generated as follows. The number of ‘clean’ images with different head poses is captured. The repository/database 160 can contain ‘clean’ images with yaw from −90 to +90 degrees (from profile right to profile left), with pitch of −60 to +60 degrees (down to up), and with roll from −40 to +40 degrees. The images can be captured with the predefined resolution with respect to the angles, i.e. the database of images captured with one-degree step for yaw and one-degree step for pitch will contain 181*121=21901 images. Each image is passed through layers of the CNN to compute a set of activation maps for each database image. The database of sets can be called an activation maps database. The head pose value for each database image can be recorded, e.g., by a magnetic head tracker or calculated using various head pose detection techniques.

At operation 440, a set of activation maps generated with respect to the reference image(s) can be identified. Such a set can be the set of activation maps associated with the reference image(s) that most correlates with the set of activation maps generated with respect to the first image. In certain implementations, such a set can be identified based on the comparing of activation maps (e.g., at 430).

At operation 450, one or more candidate(s) for modification is/are identified. In certain implementations, such candidate(s) can be identified based on a computed correlation (e.g., a statistical correlation). In certain implementations, such candidate(s) for modification can be identified based on a correlation computed between data reflected in the first set of activation maps (e.g., the activation maps generated at 420) and data reflected in a second set of activation maps associated with a second image (e.g., from the set of activation maps identified at 440). In certain implementations, such a correlation between each pair of activation maps can reflect a correlation between the set of activation maps generated with respect to the first image and a set of activation maps associate with the reference image(s).

Additionally, in certain implementations such a correlation can reflect correlation(s) between activation map(s) generated with respect to the first image and one or more activation map(s) associated with one or more reference image(s). Moreover, in certain implementations such a correlation can be computed using any number of techniques, such as those described and/or referenced herein (e.g., Spearman's rank, Pearson rank, a sum of absolute or square differences, Goodman-Kruskel gamma coefficient, etc.).

For example, as described herein, in certain implementations, various criteria can be defined to reflect whether a computed similarity/correlation reflects a result that is satisfactory (e.g., within an image recognition process). For example, a Pearson correlation coefficient (PCC) value of 0.6 can be defined as a threshold that reflects a satisfactory result (e.g., with respect to identifying content within input 130). In scenarios in which the comparison between corresponding activation maps results in a PCC value below the defined threshold, such an activation map can be identified as a candidate for modification in the CNN. Such a candidate for modification can reflect, for example, an occlusion that may affect various aspects of the processing/identification of input 130.

By way of illustration, in the scenario depicted in FIG. 1, having identified set 150B as being most correlated with set 150A (among sets associated with reference image(s) 170), a statistical correlation (e.g., a similarity metric such as PCC) can be computed with respect to the respective activation maps from such sets (150A and 150B). Such a statistical correlation can be expressed as a similarity value, e.g., between −1 and 1 (with zero reflecting no correlation, 1 reflecting a perfect correlation, and −1 reflecting a negative correlation). For example, as shown in FIG. 2, respective activation maps from set 150A and 150B can be compared and the degree of similarity/correlation between each pair of activation maps can be computed. In the scenario depicted in FIG. 2, activation map 152C can be identified as a candidate for modification, as described in detail herein.

It should be understood that a reference image can be a ‘clean’ image which has the closest characteristics to the input image. In the case of a head pose detection system, the face in the reference image has the closest yaw, pitch and roll to the yaw, pitch and roll of the face in the input image.

As described herein, in certain implementations the input image can be converted into a set 150A (e.g., a set of activation maps), and the best matching set 150B associated with reference image(s) 170 can be identified. A statistical correlation coefficient, like Pearson correlation coefficient, can be calculated between each activation map in set 150A and set 150B, and can be used as a similarity measure between input image 130 and a reference image(s) 170. The total correlation between set 150A and set 150B can be computed, for example, by calculating a sum of statistical correlation coefficients computed for each pair of the activation maps. For example, if the sets each contain 64 activation maps, the correlation coefficient between activation map 152A and activation map 152W (e.g., as shown in FIG. 2) can be added to the correlation coefficient between activation map 152B and activation map 152X, and so on until the maps number 64. The maximal total correlation value in such a scenario will be 64. In another implementation, only a specific list of activation maps (e.g., those identified or determined to be important) are used.

The reference set of activation maps with the highest total correlation value (e.g., as computed in the manner described above) is the reference image that is identified in the manner described herein and selected to fix the candidate for modification. It should be understood that the output prediction label (e.g. head pose) for the selected reference image is known. Such a reference set of activation maps with the highest total correlation together with the set of activation maps generated from the input image can be provided as the output, as described herein.

It should be understood that the new/modified/replaced activation map may be one or more of: a combination of more than one activation maps associated with more than one second/reference images, a combination of activation map(s) associated with the first image and activation map(s) associated with the second image, etc. Additionally, in certain implementations the referenced modified activation map can reflect the removal of the identified activation map (e.g., from the set of activation maps).

Additionally, in certain implementations a naive search on the database can be performed or various numerical optimization methods can be used to improve the identification/selection of the reference image. For example, a grid search can be performed, to narrow down the search bit by bit.

Additionally, in certain implementations an input image 130 can be converted to set 150A which consists of multiple activation maps (e.g., 64 activation maps). Each activation map can be considered as a small image representation and thus may contain information about the image data, such as head pose. In certain implementations, each activation map may be used independently to calculate a few head pose candidates. Later on, all the candidates can be combined to obtain/determine a final head pose output.

For example, for each map, a few “closest” activation maps from the repository/database 160 can be identified, e.g., in the manner described herein. The ground truth head pose values of the identified reference maps can be used as the head pose candidates of the current input image activation map. A final head pose is computed as a weighted combination of the head pose candidates of activation maps.

For example the closest maps for the first activation map are the first activation maps of the ‘clean’ images number 1 and 2. This means that the head pose candidates for the corresponding set 150A are head poses of the images 1 and 2. These two head pose candidates can be combined into a single head pose candidate that corresponds to set 150A Similarly, the head pose candidates for the other activation maps are computed, e.g., with respect to various head pose outputs. Then a final output head pose candidate can be computed as a weighted combination of the referenced head pose outputs.

At operation 460, the first image is processed within one or more layers of the convolutional neural network using an activation map or set of activation maps associated with the second image. In certain implementations, the first image can be processed using the activation map associated with the second image based on a determination that a statistical correlation (e.g., as computed at 450) does not meet certain predefined criteria.

For example, in certain implementations, various criteria (e.g., a defined threshold, a thresholding of the standard deviation, etc.) can be defined to reflect whether a computed similarity (e.g., the statistical correlation computed at 450) reflects a result that is satisfactory (e.g., within an image recognition process). For example, a Pearson correlation coefficient (PCC) value of 0.6 can be defined as a threshold that reflects a satisfactory result (e.g., with respect to identifying content within input 130). In scenarios in which the comparison between corresponding activation maps results in a PCC value below the defined threshold, such an activation map can be identified (e.g., at 450) as a candidate for modification in the CNN. Such a candidate for modification can reflect, for example, an occlusion that may affect various aspects of the processing/identification of input 130.

In certain implementations, an activation map (and/or a portion or segment of an activation map) generated with respect to the first image can be replaced with activation map(s) (and/or a portion or segment of activation map(s)) generated with respect to the reference image(s). For example, within a set of activation maps generated with respect to the first image (e.g., set 150A), an activation map determined not to sufficiently correlate with a corresponding activation map(s) from reference image(s) (e.g., activation map 152C as shown in FIG. 2) can be replaced or substituted with the corresponding activation map(s) from the reference image(s) (e.g., activation map 152Y from set 150B).

By way of further illustration, as shown in FIG. 2 and described herein, the respective activation maps of set 150A (corresponding to input 130) and set 150B (corresponding to reference image(s) 170) can be compared and a statistical correlation (as expressed in a similarity value) can be computed for each respective comparison. In the scenario depicted in FIG. 2, the similarity value for activation maps 152A, 152B and 152D (as compared with activation maps 152W, 152X, and 152Z, respectively, of set 150B) meets or exceeds one or more defined criteria (e.g., a PCC value threshold of 0.6). Accordingly, such activation maps can be determined to sufficiently correlate with the referenced reference image(s) (e.g., in order to enable the identification of content within input 130 via CNN 140).

In contrast, activation map 152C—as compared with activation map 152Y of set 150B—can be determined not to meet the referenced criteria (e.g., with a PCC value below 0.6). Accordingly, activation map 152C can be identified as a candidate for modification within the CNN, reflecting, for example, an occlusion that may affect various aspects of the processing/identification of input 130.

By way of further illustration, a correlation coefficient can be computed for all 64 activation maps, as well as the mean (e.g., 0.6) and standard deviation (e.g., 0.15) of such correlation coefficients. In such a scenario, activation maps that have a correlation coefficient of 1 standard deviation below the mean (here, activation maps with a correlation coefficient below 0.45) are identified (and can be replaced, as described herein).

Having identified activation map 152C as a candidate for modification within the CNN, the corresponding activation map from the reference image (here, activation map 152Y) can be replaced/substituted. In doing so, a new or updated set 250 can be generated. As shown in FIG. 2, such a set 250 can include activation maps determined sufficiently correlate with those in the reference image (here, activation maps 152A, 152B, and 152D), together with activation map(s) associated with reference image(s) that correspond to activation map(s) from the input that did not sufficiently correlated with the reference image (here, activation map 152D).

It should be understood that the described substitution/replacement operations (e.g., of the identified candidate(s) for modification) can be performed in any number of ways. For example, in certain implementations multiple reference activation maps can be combined, averaged, etc., and such a combination can be used to substitute/replace the identified candidate(s) for modification. By way of further example, various reference activation map(s) and the identified candidate(s) for modification can be can be combined, averaged, etc., and such a combination can be used to substitute/replace the identified candidate(s) for modification. By way of further example, the identified candidate(s) for modification can be ignored or removed (e.g., within the set of activation maps), and such a set of activation maps (accounting for the absence of the candidate(s) for modification) can be further processed as described herein.

Having generated a new/updated set 250, such a set can be further utilized as input with respect to one or more subsequent layer(s) 142B of CNN 140. For example, as shown in FIG. 3, set 250 (which includes activation map 152Y substituted for original activation map 152C) is input into CNN 140, for further processing (e.g., with respect to layers 142B).

At operation 470, an output is provided. In certain implementations, such an output is provided based on the processing of the set of activation maps with replacements within the second part of the CNN (e.g., at 460). Additionally, in certain implementations a validity of an output of the neural network can be quantified, e.g., based on the computed correlation. Moreover, in certain implementations content included or reflected within the first image can be identified based on the processing of the first image within the second layer of the convolutional neural network (e.g., at 460).

For example, as shown in FIG. 3, having utilized set 250 as an input with respect to layer(s) 142B of CNN 140, CNN 140 can continue its processing and provide one or more output(s) 180. In certain implementations, such output(s) can include or reflect identifications or determinations, e.g., with respect to content present within or reflected by input 130. For example, CNN 140 can provide an output identifying content within the input such as the presence of an object, a direction a user is looking, etc.

Moreover, in certain implementations, upon identifying a candidate for modification within a CNN (e.g., an occlusion causing one or more activation maps not to sufficiently correlate with corresponding activation maps within a reference image), an output associated with such reference image(s) can be selected and utilized (e.g., in lieu of substituting activation maps for further processing within the CNN, as described herein). For example, upon determining that the closest reference images are associated with certain output(s) (e.g., the identification of content within such images such as the presence of an object, a direction a user is looking, etc.), such outputs can also be associated with the image being processed.

Additionally, in certain implementations the validity of the described correction is tested. For example, in certain implementations the original (uncorrected) set 150A can be further processed through layer(s) 142B to determine an output of CNN 140 based on such inputs. The output in such a scenario can be compared with the output of CNN 140 (using set 250 in lieu of set 150A) to determine which set of inputs provides an output that more closely correlates to the output associated with the reference image(s). In scenarios in which the corrected set 250 does not cause CNN 140 to produce an output more closely correlated to that of the reference image, the described correction can be determined to be invalid (e.g., with respect to identifying content, head poses, etc., within the input). Additionally, in certain implementations, upon determining that corrected set 250 does cause CNN 140 to produce an output more closely correlated to that of the reference image, a final output can be provided that reflects, for example, a linear combination (e.g., average) between the output provided by the CNN using the corrected set and the value of an output associated with the reference image(s).

Additionally, in certain implementations the described technologies can be configured to perform one or more operations including but not limited to: receiving a first image; generating, within one or more first layers of the convolutional neural network, a first set of activation maps, the first set comprising one or more first activation maps generated with respect to the first image; comparing the first set of activation maps with one or more sets of activation maps associated with one or more second images; based on the comparing, identifying a second set of activation maps associated with the second image as the set of activation maps most correlated with the first set of activation maps; based on a statistical correlation between data reflected in at least one of the one or more first activation maps and data reflected in at least one of the one or more second activation maps, identifying one or more candidates for modification; generating a first modified set of activation maps by replacing, within the first set of activation maps, at least one of the one or more candidates for modification with at least one of the one or more second activation maps; processing the first modified set of activation maps within one or more second layers of the convolutional neural network to generate a first output; based on the first output, generating a second modified set of activation maps; processing the second modified set of activation maps within one or more third layers of the convolutional neural network to generate a second output; and providing a third output with respect to the first image based on the processing of the second modified set of activation maps within the one or more third layers of the convolutional neural network. In doing so, one or more modifications (e.g., replacement, substitution, etc.) of one or more activation maps can be performed within one or more first layers of a CNN, and output(s) can be generated based on such modified sets of activation maps, as described herein. Such outputs can then be used within further layers of the CNN, and the described technologies can perform one or more modifications (e.g., replacement, substitution, etc.) of one or more of the referenced activation maps (e.g., those previously modified), and further output(s) can be generated based on such modified sets of activation maps, as described herein. In doing so, multiple activation maps can be modified/substituted across multiple layers of a CNN, as described in detail herein.

Additionally, in certain implementations an input image 130 can be converted to set/vector 150A which consists of multiple activation maps (e.g., 64 activation maps). Each activation map can be considered as a small image representation and thus contains information about the image data, such as head pose. In certain implementations, each activation map may be used independently to calculate a few head pose candidates. Later on, all the candidates can be combined to obtain/determine a final head pose output.

For example, for each set of activation maps, several activation maps from repository/database 160 can be identified as being the ‘closest,’ e.g., in the manner described herein. The ground truth head pose values of the identified reference maps can be used as the head pose candidates of the current input image activation map. A final head pose can be computed as a weighted combination of the head pose candidates of activation maps.

For example, the closest maps for the first activation map are the first activation maps of the ‘clean’ images number 1 and 2. This means that the head pose candidates for the corresponding set 150A are head poses of the images 1 and 2. These two head pose candidates can be combined into a single head pose candidate that corresponds to vector 150A. Similarly, the head pose candidates for the other activation maps are computed, e.g., with respect to various head pose outputs. Then a final output head pose candidate can be computed as a weighted combination of the referenced head pose outputs.

In certain implementations the described technologies can be used for detection and correction of errors in the input to convolutional neural networks (such an input can be, for example, an image). Examples of such an error include but are not limited to: a physical occlusion of the captured object (e.g. a hand or a cup occluding a face of a user) or data corruption of any kind (e.g. saturated image regions, sudden lens pollution, corrupted pixels of the sensor, image region pixelization due to the wrong encoding/decoding etc.).

In certain implementations the described technologies can also be extended to analyze error(s) detected in the input to convolutional neural networks. It is possible to associate some of the activation maps with the image regions (as well as with the image characteristics, like content, color distribution etc.). Therefore, such activation maps can be associated with low correlation (activation maps that do not sufficiently correlate with corresponding activation maps within a reference image) with the image regions that are potentially occluded or corrupted. The information presented in these activation maps can be used to define the occluded regions, e.g., of face parts. Also, the information about the nature of the occlusion or corruption can be extracted from these activation maps.

The activation maps with low correlation can be later used/processed (e.g. through an additional CNN part) in order to extract information about the location and the type of occlusion: the statistics of the occluded regions can be collected and analyzed (e.g. occlusion of the upper part of the head may define a hat; such an occlusion may not be significant for certain applications, like driver monitoring and thus may be ignored; the occlusion of the left or right face part may be more critical for the driver monitoring, because it may define a cell phone used while driving, in this case an object detection method (e.g. an additional CNN) may be applied in order to identify the object or the reason of occlusion).

An additional convolutional neural network (or its part, similar to 142B) can be used to perform online learning for the task of the object categorization. The activation maps with low correlation may be used as an input to the object classification convolutional neural network (similar to 142B) and category (class/type/nature) of the detected occlusion may be learned.

The data learned (online or offline) by such a convolutional neural network (or any other object classification technique, either deterministic or stochastic) can later be used to improve the performance of the initial system described herein. For example, the detected occlusion can be detected and learned to be a new face artifact (e.g. beard, moustache, tattoo, makeup, haircut etc.), or accessories (e.g. glasses, piercing, hat, earing). In this case the occlusion can be treated as a face feature and as such a feature may be added to the training procedure and/or the images containing such an artifact may be added to the reference data set. Selecting an image to be added to the reference data may be performed using information associated with the detected face artifact or accessories (e.g. image in which the user is detected wearing sunglasses will be in daytime; an image in which the user is detected wearing earing, will be used during the current session, while an image in which the user has a new tattoo will be used permanently.

One application of the described system to an object monitoring system for in-car environments can be illustrated with respect to safety belt detection, child detection or any other specific object detection. For example, the analysis with respect to whether a child seat is empty or not may be performed in conjunction with the system described herein, e.g., without the use of other object detection techniques. First, the activation maps associated with the location of the child seat can be identified. Second, if the reference data set contains images with empty child seats, those activation maps of the input image, which are associated with the child seat location, are compared with the corresponding activation maps of the reference images of the empty child seats and a correlation measure is computed. A criterion (e.g. a threshold) can be applied in order to determine whether the compared activation maps are similar enough or not. If the compared activation maps are similar enough (e.g. computed correlation is above the threshold), then a final answer/output of the empty chair is returned. If the compared activation maps differ too much (e.g. computed correlation is below the threshold), then the signal “Baby is in the chair!” may be alerted.

It should also be noted that while the system described herein is illustrated with respect to error correction in convolutional neural networks, the described system can also be implemented in any number of additional or alternative settings or contexts and towards any number of additional objectives.

The described technologies may be implemented within and/or in conjunction with various devices or components such as any digital device, including but not limited to: a personal computer (PC), an entertainment device, set top box, television (TV), a mobile game machine, a mobile phone or tablet, e-reader, smart watch, digital wrist armlet, game console, portable game console, a portable computer such as laptop or ultrabook, all-in-one, TV, connected TV, display device, a home appliance, communication device, air-condition, a docking station, a game machine, a digital camera, a watch, interactive surface, 3D display, an entertainment device, speakers, a smart home device, IoT device, IoT module, smart window, smart glass, smart light bulb, a kitchen appliance, a media player or media system, a location based device; and a mobile game machine, a pico projector or an embedded projector, a medical device, a medical display device, a vehicle, an in-car/in-air Infotainment system, drone, autonomous car, self-driving car, flying vehicle, navigation system, a wearable device, an augment reality enabled device, a wearable goggles, a virtual reality device, a location based device, a robot, social robot, android, interactive digital signage, digital kiosk, vending machine, an automated teller machine (ATM), and/or any other such device that can receive, output and/or process data.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “processing,” “providing,” “identifying,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Aspects and implementations of the disclosure also relate to an apparatus for performing the operations herein. A computer program to activate or configure a computing device accordingly may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The present disclosure is not described with reference to any particular programming language. It will be appreciated that a variety of programming languages may be used to implement the teachings of the disclosure as described herein.

As used herein, the phrase “for example,” “such as,” “for instance,” and variants thereof describe non-limiting embodiments of the presently disclosed subject matter. Reference in the specification to “one case,” “some cases,” “other cases,” or variants thereof means that a particular feature, structure or characteristic described in connection with the embodiment(s) is included in at least one embodiment of the presently disclosed subject matter. Thus the appearance of the phrase “one case,” “some cases,” “other cases,” or variants thereof does not necessarily refer to the same embodiment(s).

Certain features which, for clarity, are described in this specification in the context of separate embodiments, may also be provided in combination in a single embodiment. Conversely, various features which are described in the context of a single embodiment, may also be provided in multiple embodiments separately or in any suitable sub combination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments have been described. Other embodiments are within the scope of the following claims.

Certain implementations are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example implementations, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some implementations, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module can also include programmable logic or circuitry that is temporarily configured by software to perform certain operations. For example, a hardware module can include software executed by a processor or other programmable processor. Once configured by such software, hardware modules become specific machines (or specific components of a machine) uniquely tailored to perform the configured functions. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering implementations in which hardware modules are temporarily configured (e.g., programmed), each of the hardware modules need not be configured or instantiated at any one instance in time. For example, where a hardware module comprises a processor configured by software to become a special-purpose processor, the processor can be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In implementations in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API).

The performance of certain of the operations can be distributed among the processors, not only residing within a single machine, but deployed across a number of machines. In some example implementations, the processors or processor-implemented modules can be located in a single geographic location (e.g., within a home environment, an office environment, or a server farm). In other example implementations, the processors or processor-implemented modules can be distributed across a number of geographic locations.

The modules, methods, applications, and so forth described in conjunction with FIGS. 1-4 are implemented in some implementations in the context of a machine and an associated software architecture. The sections below describe representative software architecture(s) and machine (e.g., hardware) architecture(s) that are suitable for use with the disclosed implementations.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture can yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

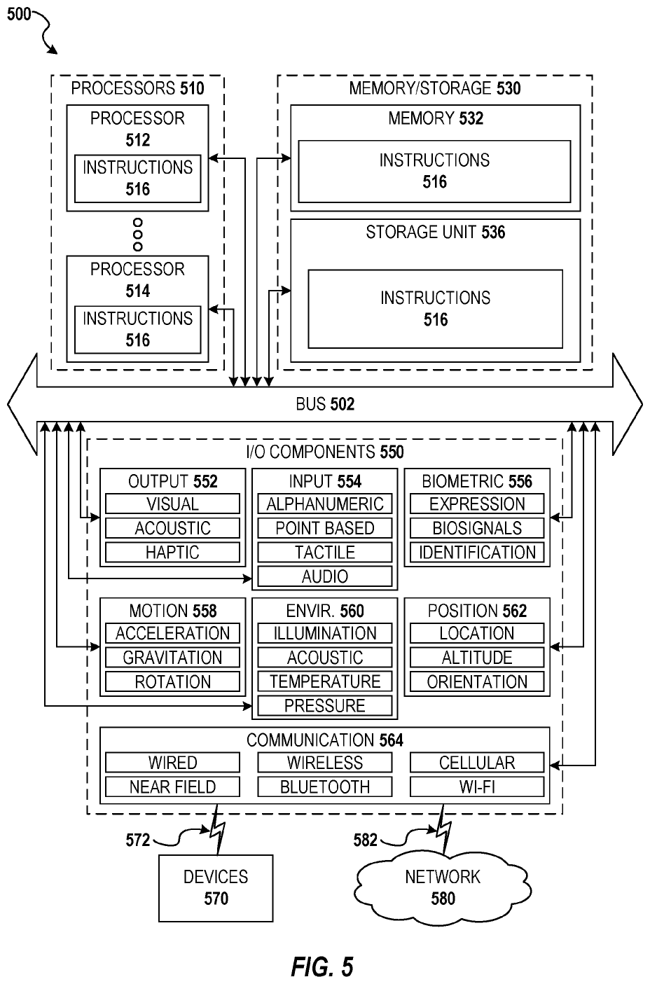

FIG. 5 is a block diagram illustrating components of a machine 500, according to some example implementations, able to read instructions from a machine-readable medium (e.g., a machine-readable storage medium) and perform any one or more of the methodologies discussed herein. Specifically, FIG. 5 shows a diagrammatic representation of the machine 500 in the example form of a computer system, within which instructions 516 (e.g., software, a program, an application, an applet, an app, or other executable code) for causing the machine 500 to perform any one or more of the methodologies discussed herein can be executed. The instructions 516 transform the non-programmed machine into a particular machine programmed to carry out the described and illustrated functions in the manner described. In alternative implementations, the machine 500 operates as a standalone device or can be coupled (e.g., networked) to other machines. In a networked deployment, the machine 500 can operate in the capacity of a server machine or a client machine in a server-client network environment, or as a peer machine in a peer-to-peer (or distributed) network environment. The machine 500 can comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 516, sequentially or otherwise, that specify actions to be taken by the machine 500. Further, while only a single machine 500 is illustrated, the term “machine” shall also be taken to include a collection of machines 500 that individually or jointly execute the instructions 516 to perform any one or more of the methodologies discussed herein.

The machine 500 can include processors 510, memory/storage 530, and I/O components 550, which can be configured to communicate with each other such as via a bus 502. In an example implementation, the processors 510 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) can include, for example, a processor 512 and a processor 514 that can execute the instructions 516. The term “processor” is intended to include multi-core processors that can comprise two or more independent processors (sometimes referred to as “cores”) that can execute instructions contemporaneously. Although FIG. 5 shows multiple processors 510, the machine 500 can include a single processor with a single core, a single processor with multiple cores (e.g., a multi-core processor), multiple processors with a single core, multiple processors with multiples cores, or any combination thereof.

The memory/storage 530 can include a memory 532, such as a main memory, or other memory storage, and a storage unit 536, both accessible to the processors 510 such as via the bus 502. The storage unit 536 and memory 532 store the instructions 516 embodying any one or more of the methodologies or functions described herein. The instructions 516 can also reside, completely or partially, within the memory 532, within the storage unit 536, within at least one of the processors 510 (e.g., within the processor's cache memory), or any suitable combination thereof, during execution thereof by the machine 500. Accordingly, the memory 532, the storage unit 536, and the memory of the processors 510 are examples of machine-readable media.

As used herein, “machine-readable medium” means a device able to store instructions (e.g., instructions 516) and data temporarily or permanently and can include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 516. The term “machine-readable medium” shall also be taken to include any medium, or combination of multiple media, that is capable of storing instructions (e.g., instructions 516) for execution by a machine (e.g., machine 500), such that the instructions, when executed by one or more processors of the machine (e.g., processors 510), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 550 can include a wide variety of components to receive input, provide output, produce output, transmit information, exchange information, capture measurements, and so on. The specific I/O components 550 that are included in a particular machine will depend on the type of machine. For example, portable machines such as mobile phones will likely include a touch input device or other such input mechanisms, while a headless server machine will likely not include such a touch input device. It will be appreciated that the I/O components 550 can include many other components that are not shown in FIG. 5. The I/O components 550 are grouped according to functionality merely for simplifying the following discussion and the grouping is in no way limiting. In various example implementations, the I/O components 550 can include output components 552 and input components 554. The output components 552 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 554 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example implementations, the I/O components 550 can include biometric components 556, motion components 558, environmental components 560, or position components 562, among a wide array of other components. For example, the biometric components 556 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 558 can include acceleration sensor components (e.g., accelerometer), gravitation sensor components, rotation sensor components (e.g., gyroscope), and so forth. The environmental components 560 can include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that can provide indications, measurements, or signals corresponding to a surrounding physical environment. The position components 562 can include location sensor components (e.g., a Global Position System (GPS) receiver component), altitude sensor components (e.g., altimeters or barometers that detect air pressure from which altitude can be derived), orientation sensor components (e.g., magnetometers), and the like.

Communication can be implemented using a wide variety of technologies. The I/O components 550 can include communication components 564 operable to couple the machine 500 to a network 580 or devices 570 via a coupling 582 and a coupling 572, respectively. For example, the communication components 564 can include a network interface component or other suitable device to interface with the network 580. In further examples, the communication components 564 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 570 can be another machine or any of a wide variety of peripheral devices (e.g., a peripheral device coupled via a USB).

Moreover, the communication components 564 can detect identifiers or include components operable to detect identifiers. For example, the communication components 564 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information can be derived via the communication components 564, such as location via Internet Protocol (IP) geolocation, location via Wi-Fi® signal triangulation, location via detecting an NFC beacon signal that can indicate a particular location, and so forth.

In various example implementations, one or more portions of the network 580 can be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 580 or a portion of the network 580 can include a wireless or cellular network and the coupling 582 can be a Code Division Multiple Access (CDMA) connection, a Global System for Mobile communications (GSM) connection, or another type of cellular or wireless coupling. In this example, the coupling 582 can implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 516 can be transmitted or received over the network 580 using a transmission medium via a network interface device (e.g., a network interface component included in the communication components 564) and utilizing any one of a number of well-known transfer protocols (e.g., HTTP). Similarly, the instructions 516 can be transmitted or received using a transmission medium via the coupling 572 (e.g., a peer-to-peer coupling) to the devices 570. The term “transmission medium” shall be taken to include any intangible medium that is capable of storing, encoding, or carrying the instructions 516 for execution by the machine 500, and includes digital or analog communications signals or other intangible media to facilitate communication of such software.

Throughout this specification, plural instances can implement components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components. These and other variations, modifications, additions, and improvements fall within the scope of the subject matter herein.

Although an overview of the inventive subject matter has been described with reference to specific example implementations, various modifications and changes can be made to these implementations without departing from the broader scope of implementations of the present disclosure. Such implementations of the inventive subject matter can be referred to herein, individually or collectively, by the term “invention” merely for convenience and without intending to voluntarily limit the scope of this application to any single disclosure or inventive concept if more than one is, in fact, disclosed.

The implementations illustrated herein are described in sufficient detail to enable those skilled in the art to practice the teachings disclosed. Other implementations can be used and derived therefrom, such that structural and logical substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

What is claimed is:

1. A system for quantifying the validity of an output of a convolutional neural network, the system comprising:
a processing device; and
a memory coupled to the processing device and storing instructions that, when executed by the processing device, cause the system to perform operations comprising:
receiving a first image;
generating, within a first layer of the convolutional neural network, a first activation map with respect to the first image;
computing a correlation between data reflected in the first activation map and data reflected in a second activation map associated with a second image;
based on the computed correlation, using a linear combination of the first activation map or the second activation map to process the first image within a second layer of the convolutional neural network; and
providing an output based on the processing of the first image within the second layer of the convolutional neural network.

2. The system of claim 1, wherein the second image comprises one or more image(s) captured prior to the first image by a device that captured the first image.

3. The system of claim 1, wherein generating a first activation map comprises generating a set of activation maps with respect to the first image.

4. The system of claim 3, wherein computing a correlation comprises computing a correlation between the set of activation maps generated with respect to the first image and a set of activation maps associated with the second image.

5. The system of claim 1, wherein computing a correlation comprises computing one or more correlations between one or more activation maps generated with respect to the first image and one or more activation maps associated with the second image.

6. The system of claim 1, wherein the memory further stores instructions to cause the system to perform operations comprising:
comparing a set of activation maps generated with respect to the first image with one or more sets of activation maps associated with the second image; and
based on the comparing, identifying a set of activation maps associated with the second image as the set of activation maps most correlated with the set of activation maps generated with respect to the first image.

7. The system of claim 1, wherein using the activation map associated with the second image comprises replacing the first activation map associated with the first image with the activation map associated with the second image.

8. The system of claim 1, wherein using the activation map associated with the second image comprises replacing, within a set of activation maps generated with respect to the first image, the first activation map generated with respect to the first image with the activation map associated with the second image.

9. The system of claim 1, wherein using a combination of the first activation map or the second activation map comprises replacing, within a set of activation maps associated with the first image, one or more first activation maps associated with the first image with one or more activation maps associated with the second image.

10. The system of claim 1, wherein providing an output comprises based on the computed correlation, quantifying the validity of an output of the neural network.

11. The system of claim 1, wherein using the first activation map or the second activation map to process the first image within a second layer of the convolutional neural network comprises based on a predefined criteria in relation to the computed correlation, using the first activation map or the second activation map to process the first image within a second layer of the convolutional neural network.

12. The system of claim 1, wherein the predefined criteria comprises a defined threshold.

13. The system of claim 1, wherein computing a correlation comprises computing a correlation between the first activation map and one or more second activation maps associated with one or more second images.

14. The system of claim 1, wherein using the first activation map or the second activation map comprises using the second activation map to process the first image within one or more layers of the convolutional neural network.

15. The system of claim 1, wherein computing a correlation comprises computing one or more correlations between the first activation map and one or more second activation maps associated with one or more second images.

16. The system of claim 1, wherein providing an output comprises identifying content within the first image based on the processing of the first image within the second layer of the convolutional neural network.

17. A method for quantifying the validity of an output of a convolutional neural network, the method comprising:
receiving a first image;
generating, within a first layer of the convolutional neural network, a first set of activation maps, the first set comprising a first activation map generated with respect to the first image;
computing a statistical correlation between data reflected in the first activation map and data reflected in a second activation map associated with a second image;
based on a determination that the correlation does not meet a predefined criteria, generating a modified set of activation maps by replacing, within the first set of activation maps, the first activation map generated with respect to the first image with the activation map associated with the second image;
processing the corrected set of activation maps within a second layer of the convolutional neural network; and
providing an output with respect to the first image based on the processing of the corrected set of activation maps within the second layer of the convolutional neural network.

18. The method of claim 17, further comprising:
comparing the first set of activation maps with one or more sets of activation maps associated with the second image; and
based on the comparing, identifying a set of activation maps associated with the second image as the set of activation maps most correlated with the first set of activation maps.

19. A non-transitory computer readable medium having instructions stored thereon that, when executed by a processing device, cause the processing device to quantify the validity of an output of a convolutional neural network by performing operations comprising:
receiving a first image;
generating, within one or more first layers of the convolutional neural network, a first set of activation maps, the first set comprising one or more first activation maps generated with respect to the first image;
identifying a second set of activation maps associated with a second image as a set of activation maps that correlates with the first set of activation maps;
based on a correlation between data reflected in at least one of the one or more first activation maps and data reflected in at least one of the one or more second activation maps, identifying one or more candidates for modification;
generating a modified set of activation maps by replacing, within the first set of activation maps, at least one of the one or more candidates for modification with at least one of the one or more second activation maps;
processing the modified set of activation maps within one or more second layers of the convolutional neural network; and
providing an output with respect to the first image based on the processing of the modified set of activation maps within the one or more second layers of the convolutional neural network.

20. The non-transitory computer readable medium of claim 19, wherein providing an output comprises identifying content within the first image based an identification of the content within the second image.
